(19) United States
(12) Patent Application Publication
(10) Pub. No.: US 2013/0264791 A1
(43) Pub. Date: Oct. 10, 2013

(54) HAND RIM FOR PROPELLING A WHEELCHAIR

(71) Applicants: BRANDON HANDEL, VISALIA, CA (US); JACOB BARBER, VISALIA, CA (US)

(72) Inventors: BRANDON HANDEL, VISALIA, CA (US); JACOB BARBER, VISALIA, CA (US)

(21) Appl. No.: 13/749,456

(22) Filed: Jan. 24, 2013

Related U.S. Application Data
(60) Provisional application No. 61/590,082, filed on Jan. 24, 2012.

(51) Int. Cl. A61G 5/02

(52) U.S. Cl. CPC A61G 5/026
USPC 280/250.1; 264/271.1; 156/245

(57) ABSTRACT

A wheelchair hand rim with mounting tabs and a resilient layer that provides for increased grip of and insulation from the core of the hand rim, and a method for making a wheelchair hand rim. The wheelchair hand rim may be provided with a variety of traction ring configurations.

### PRIORITY/CROSS-REFERENCE TO RELATED APPLICATIONS

This application claims the benefit of U.S. Provisional Application No. 61/590,082, filed Jan. 24, 2012, the disclosure of which is incorporated by reference.

### BACKGROUND

The disclosure generally relates to the field of wheelchair accessories. Manually operated wheelchair wheels are typically equipped with a hand rim or grip ring that is connected to the wheelchair wheels and provide a means for the user to turn the wheels. A wheelchair user spins the hand rim to propel the wheelchair; and the user grasps a spinning hand rim to slow or stop the wheelchair. A typical hand rim is bare metal, which is often difficult to grasp when wet or cold. A user's hands can slip on the hand rim and the hand rim can be quite uncomfortable to grasp during inclement weather.

### SUMMARY OF THE DISCLOSURE

Disclosed is a hand rim for use in propelling a wheelchair, the hand rim having a grip-improving, insulative cover. The hand rim, or grip ring, is attachable to a wheelchair by several mounting tabs. The mounting tabs are attached to a circular hand rim core, which is typically metal, and which forms the internal structure of the hand rim. The hand rim core is covered by a layer of resilient material—referred to herein as a resilient layer—that provides for an improved grip of the hand rim. The resilient layer also insulates a user's hand from the hand rim core. The improved gripping surface of the resilient layer provides the user with better ability to grip the hand rim and thus more readily propel the wheelchair. The improved gripping surface also provides braking friction when a user squeezes a spinning hand rim, thus allowing a user to more quickly slow or stop the wheelchair.

Still other features and advantages of the present disclosure will become readily apparent to those skilled in this art. Accordingly, the drawings and description of the preferred embodiments are to be regarded as illustrative in nature, and not as restrictive in nature.

### BRIEF DESCRIPTION OF THE DRAWINGS

FIG. 1 is a perspective view of one embodiment of the disclosed wheelchair hand rim.

FIG. 2 is a perspective view of one embodiment of the disclosed wheelchair hand rim.

FIG. 3 is a perspective view of one embodiment of the disclosed resilient layer of the disclosed wheelchair hand rim.

FIG. 4 is a perspective view of one embodiment of the disclosed resilient layer of the disclosed wheelchair hand rim.

FIG. 4A is a perspective view of one embodiment of the disclosed wheelchair hand rim.

FIG. 5 is a flow chart illustrating a method of making the disclosed wheelchair hand rim.

FIG. 6 is a flow chart illustrating a method of making the disclosed wheelchair hand rim.

### DETAILED DESCRIPTION

While the present disclosure is susceptible of various modifications and alternative constructions, certain illustrated embodiments thereof have been shown in the drawings and will be described below in detail. It should be understood, however, that there is no intention to limit the disclosed concepts to any specific form, but, on the contrary, to cover all modifications, alternative constructions, and equivalents.

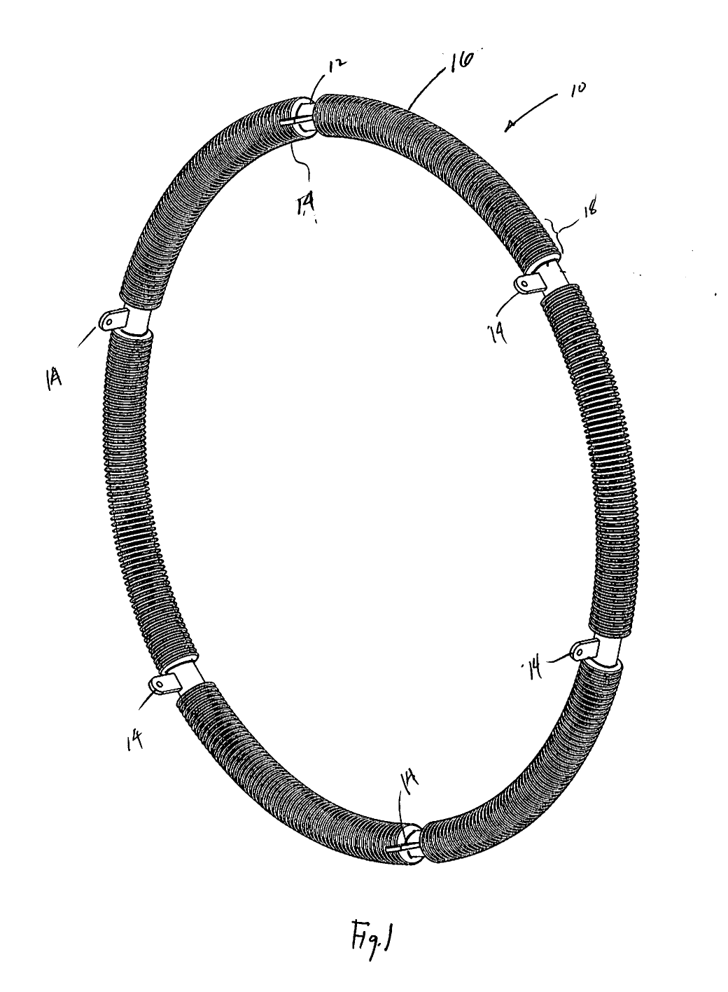

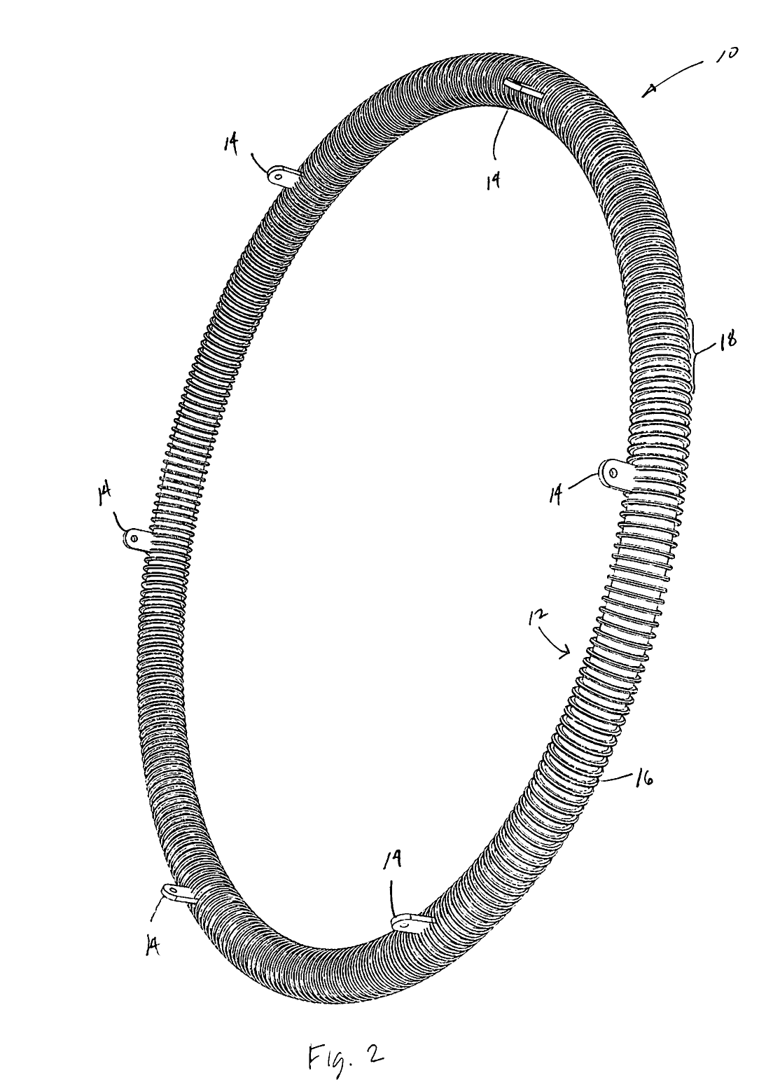

FIG. 1 shows a hand rim 10 which is comprised of a hand rim core 12, a plurality of mounting tabs 14, and a resilient layer 16. FIG. 2 likewise shows a hand rim 10 comprised of a hand rim core 12, a plurality of mounting tabs 14, and resilient layer 16. Along the resilient layer 16 are a number of traction rings 18. The hand rim 10 is susceptible of a number of embodiments, but they each have a generally circular hand rim core 12 and integral mounting tabs 14 and are configured for attachment to a wheelchair wheel. The resilient layer 16 covers and surrounds the hand rim core 12, providing the user of the hand rim 10 additional grip of, and insulation from the hand rim core 12. The traction rings 18 are particularly adapted to increase the user's grip.

The hand rim core 12 is preferably made of aluminum, but other metals, hard plastics, or composite materials are also suitable. The hand rim 12 preferably has a cross-sectional diameter of from 0.5 inch to two (2) inches, with one (1) inch a typical diameter. The hand rim core 12 typically forms a generally circular loop with a diameter of from approximately 50.8 millimeters to 711 millimeters

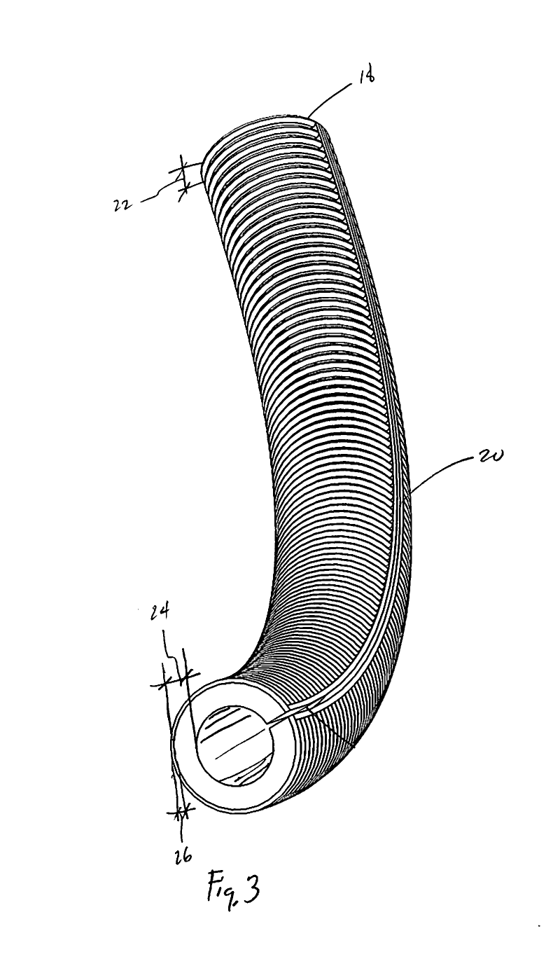

FIG. 3 shows a section of the resilient layer 16 with traction rings 18, an inner circumferential seam 20, uniform space 22 between the traction rings 18, and a thickness 24, which is measured from the surface of the hand rim core 12 to the exterior of the traction rings 18 in a plane normal to the surface of the hand rim core 12. The inner circumferential seam 12 provides for mounting of the resilient layer 16 to the hand rim core 12.

As seen in FIG. 3, the traction rings 18 are separated from one another by a uniform space 22. The traction rings 18 extend radially outward from the hand rim core 12, and, as viewed in the cross section, form concentric circles around the hand rim core 12. The traction rings 18 have a width from approximately one (1) millimeter to approximately ten (10) millimeters, with four (4) millimeters being ideal. The traction rings 18 are separated by a uniform space 22, from between 0.15 millimeter to ten (10) millimeters apart, with a space 22 of three (3) millimeters being ideal. The resilient layer 16 has a thickness 24 as measured from the hand rim core 12 at an angle normal to the surface of the hand rim core 12 outward. This thickness 24 could be from 0.05 inches to 0.5 inch thick as measured in a plane normal to the surface of the hand rim core 12. The traction rings 18 themselves could have a thickness 26 from 1 millimeter to 40 millimeters, which thickness is measured from the outermost edge of the traction rings 18 to the surface of the resilient layer 16 in the space between traction rings, in a plane normal to the hand rim 10. The traction rings 18 are configured in various embodiments of the hand rim 10, such that the resilient layer 16 comprises from two (2) to twenty (20) traction rings 18 per inch, as measured around the circumference of the hand rim, with ten (10) traction rings 18 per inch being ideal.

In the preferred embodiment, the resilient layer 16 has a thickness 24 of 0.22 inch as measured from the surface of the hand rim core 12 to the edge of the traction rings 18 in a plane normal to the hand rim core 12 surface. The spaces 22 between the traction rings 18 have a depth of 0.18 inch as measured from the surface of the traction rings 18 to the base of the traction rings 18. The material for the resilient layer 16 could be any number of materials that provide for durability and grip-enhancement. Such materials are typically rubber-type compounds, with examples seen on kitchen utensil grips and yard tool grips. The resilient layer 16 could be made from Santropene®, Thermoplastic elastimer (TPE), a mixture of EPDM rubber and polypropylene, Hypalon®, polyurethane, silicone, nitrile, Butyl®, neoprene and Buna-N®, SBR, ebonite, or other similarly resilient material which is suitable for ejection molding. The resilient layer 16 has a twenty five (25) to fifty five (55) durometer hardness, with the best mode being thirty five (35) durometer hardness.

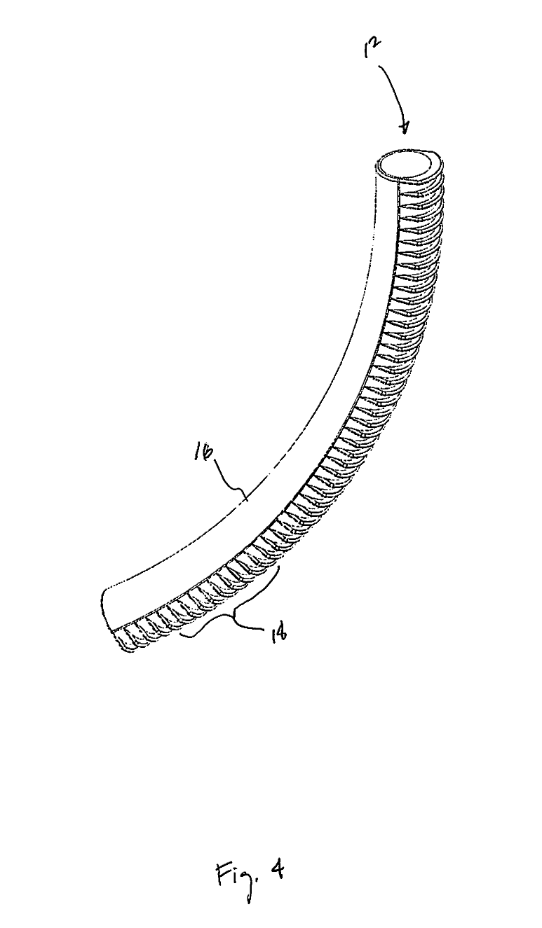

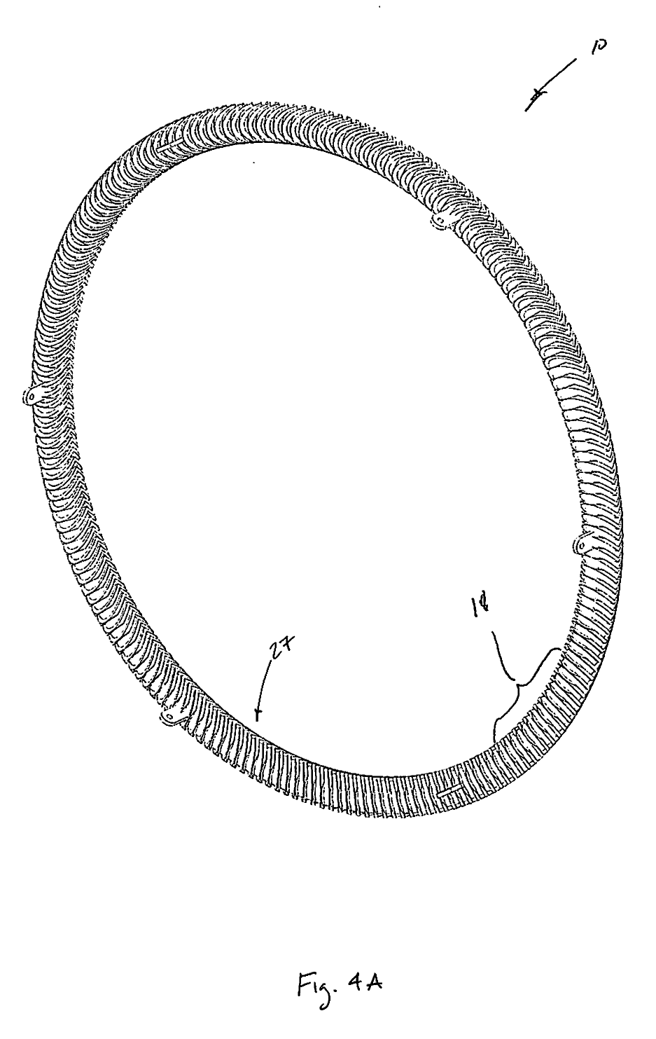

The traction rings 18 could be arranged in any number of configurations, however, two preferred embodiments are shown in FIGS. 3 and 4. In FIG. 3, the traction rings 18 are uniformly spaced about the resilient layer 16 and, as viewed in the cross section, form concentric circles about the hand rim 12. In FIG. 4, which is informally referred to as a “Mohawk pattern,” the traction rings 18 are arranged in arcs such that they do not form concentric circles about the hand rim core 12. Rather, the traction rings 18 only protrude from the upper most portion of the resilient layer 16 (with “upper” being a reference to the direction toward the top, left of the page in the view shown in FIG. 4).

The resilient layer 16 may also have traction rings 18 covering its entirety, as shown in FIG. 2. Or, the resilient layer 16 may have a pattern of traction rings 18 such that the area of the resilient layer 16 in the proximity of the mounting tabs 14 is without traction rings 18, as seen in FIG. 1. In FIG. 1, the resilient layer 16 covers the entirety of the hand rim core 12, but the traction rings 18 are not provided in the vicinity of the mounting tabs 14. In other embodiments, the resilient layer 16 could comprise a plurality of independent sections. In such an embodiment, the space between each of the mounting tabs 14 would have an independent section of resilient layer 16.

The traction rings 18 may be shaped in a variety of ways. FIG. 4A shows one embodiment of the hand rim 10 in which the traction rings 18 are configured in a chevron shape 27. The traction rings 18 could also be shaped in any desired configuration, including: round, oval, diamond, chevron, or square.

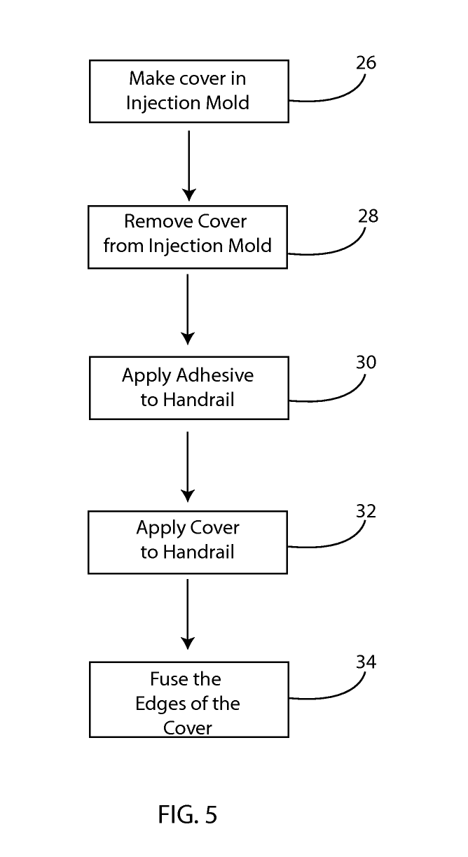

The resilient layer 16 may be formed in a variety of ways. As is shown in FIG. 5, one such method is to mold the resilient layer 16 and then adhere it to the hand rim core 12. This method requires the steps of first making a resilient layer 16 by injecting 16 a liquid form of the resilient material into a mold, wherein the mold is formed to create the traction rings 18. The mold also creates the inner circumferential seam 20. Next, in this injection molding method, one must remove 28 the resilient layer from the mold after it is cooled. Then, the method requires one to apply 30 an adhesive to the hand rim core 12. Next, one applies 32 the resilient layer to the adhesive material about the hand rim core 12 and finally fuses 34 the edges of the resilient layer at the inner circumferential seam 20.

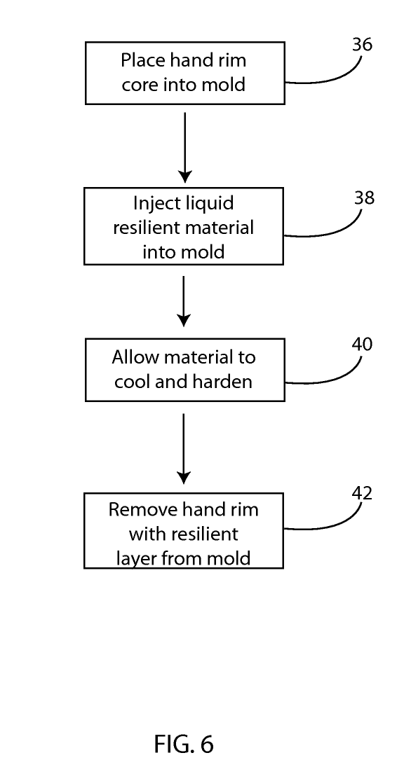

Alternatively, as shown in FIG. 6, one may create the resilient layer 16 by first placing 36 the hand rim core 12 into a mold and injecting 38 a liquid form of a resilient material into the mold such that the material adheres to and about the hand rim core 12. Next, allow 40 the resilient material to cool and harden about the hand rim core 12. Then remove 42 the hand rim 10 with resilient layer 16 from the mold. The mold may be equipped with a design such that the traction rings 18 are formed into the resilient layer 16. Either of these methods of creating the resilient layer 16 may be modified such that the resilient layer 16 is created in a plurality of discreet sections.

While certain exemplary embodiments are shown in the Figs. and described, it is to be distinctly understood that the present disclosure is not limited thereto but may be variously embodied to practice within the scope of the following claims. From the foregoing description, it will be apparent that various changes may be made without departing from the spirit and scope of the disclosure as defined by the following claims.

What is claimed is:

1. A hand rim for use on a wheelchair wheel, said hand rim comprising:
a generally circular hand rim core with integral mounting tabs configured for attachment to a wheelchair wheel;
a resilient layer covering and surrounding said hand rim core; wherein said resilient layer comprises a plurality of traction rings extending radially from said resilient layer, each of said rings spaced apart from adjacent rings.

2. The hand rim of claim 1 wherein said traction rings have a width from one to ten millimeters.

3. The hand rim of claim 1 wherein each of said traction rings is uniformly spaced apart a distance from 0.15 millimeter to ten millimeters.

4. The hand rim of claim 1 wherein said traction rings extend normally from said resilient layer from one to forty millimeters.

5. The hand rim of claim 1 wherein said traction rings are configured such that said resilient layer comprises from five to fifteen rings per inch as measured around the circumference of said hand rim.

6. The hand rim of claim 1 wherein said resilient layer is from 0.05 inch to one-half inch thick as measured in a plane normal to the surface of said hand rim core.

7. A hand rim for use on a wheelchair wheel, said hand rim comprising:
a generally circular hand rim core with integral mounting tabs configured for attachment to a wheelchair wheel;
a plurality of sections of resilient layer covering and surrounding said hand rim core; wherein
each of said sections of resilient layer comprises a plurality of traction rings extending radially from said resilient layer, each of said rings spaced apart from adjacent rings.

8. The hand rim of claim 7 that comprises six sections of resilient layer.

9. The hand rim of claim 7 wherein said traction rings have a width from one to ten millimeters.

10. The hand rim of claim 7 wherein each of said traction rings is uniformly spaced apart a distance from 0.15 to ten millimeters.

11. The hand rim of claim 7 wherein said traction rings extend normally from said resilient layer from one to forty millimeters.

12. The hand rim of claim 7 wherein said traction rings are configured such that said resilient layer comprises from two to twenty rings per inch as measured around the circumference of said hand rim.

13. The hand rim of claim 7 wherein said traction rings are configured such that said resilient layer comprises from five to fifteen rings per inch as measured around the circumference of said hand rim.

14. The hand rim of claim 7 wherein said resilient layer is from 0.05 inch to one-half inch thick as measured in a plane normal to the surface of said hand rim.

15. A method of making a hand rim for use on a wheelchair wheel, said method comprising the steps of:
(a) making a resilient layer for a wheelchair hand rim by injecting a resilient material into a mold, said mold forming a resilient layer with circular traction rings and an inner circumferential seam;
(b) removing said resilient layer from said mold;
(c) applying adhesive to said wheelchair hand rim;
(d) applying said resilient layer to said wheelchair hand rim; and
(e) fusing the seam of said resilient layer such that said wheelchair hand rim is surrounded by said resilient layer.

16. The method of claim 14 that comprises the additional step, before step (d), of dividing said resilient layer into a plurality of segments.

17. The method of claim 14 that comprises the additional step, before step (d), of dividing said resilient in six segments.

18. A method of making a hand rim for use on a wheelchair wheel, said method comprising the steps of:
(a) providing a hand rim core having mounting tabs configured for engagement with a wheel of a wheelchair;
(b) placing said hand rim core in a mold shaped to define a covering over said hand rim core;
(c) injecting a resilient material into said mold, said mold forming a resilient layer with traction rings about said hand rim core, said traction rings radially extending from said hand rim core;
(d) allowing said resilient material to cool and harden about said hand rim core; and
(e) removing said hand rim core and resilient layer from said mold, exposing said traction rings.

19. The method of claim 17 wherein said mold is configured to provide a plurality of distinct sections of said resilient layer.

20. The method of claim 17 wherein said mold is configured to provide six distinct sections of said resilient layer.
